(19) United States
(12) Patent Application Publication
(10) Pub. No.: US 2015/0127209 A1
(43) Pub. Date: May 7, 2015

(54) BIRD REPELLENT SYSTEM

(71) Applicant: KING FAHD UNIVERSITY OF PETROLEUM AND MINERALS, Dhahran (SA)

(72) Inventors: AHMED Z. AL-GARNI, DHAHRAN (SA); WAEL G. ABDELRAHMAN, DHAHRAN (SA)

(73) Assignee: KING FAHD UNIVERSITY OF PETROLEUM AND MINERALS, Dhahran (SA)

(21) Appl. No.: 14/072,785

(22) Filed: Nov. 5, 2013

(51) Int. Cl. A01M 29/18; G05D 1/00

(52) U.S. Cl. CPC A01M 29/18; G05D 1/0088
USPC 701/26; 367/139

(57) ABSTRACT

The bird repellent system is particularly adapted to repel various species of birds on and around airports, but may be readily adapted for use in other environments where birds have become a nuisance or hazard. The system includes both a ground vehicle and an airborne vehicle to optimize the effect against both sitting birds and birds in flight. Both vehicles are unmanned and operate autonomously, or by remote control as drones. The airborne vehicle is preferably a quad rotor craft for very slow and hovering flight. Both vehicles are equipped with GPS guidance and are preprogrammed to travel about a predetermined area or route. The two vehicles communicate with one another for optimum effect. Both vehicles include audio systems to broadcast startling sounds and/or bird distress cries in sound frequencies audible to humans as well as in ultrasonic frequencies known to be audible to various species of birds.

### BACKGROUND OF THE INVENTION

1. Field of the Invention

The present invention relates generally to animal repellent systems, and particularly to a bird repellent system including remotely or autonomously operated ground and airborne drone vehicles, the system being adapted particularly for use on and around airports.

2. Description of the Related Art

Airports and the surrounding areas that are often located near airports, e.g., landfills and other open land, open areas of water, etc., tend to attract most species of birds and fowl. Such areas are attractive to birds due to the plentiful low vegetation, insects and other small animal life available for feeding, and the suitable nesting grounds that such low vegetation provides for many bird species. While such birds tend to become acclimatized to aircraft noise and movement, they are not sedentary, and tend to fly for various purposes and at various times of day. While it is possible to predict the movements of some bird species to some extent, the fact remains that bird flight over and near airports is essentially impossible to predict with any significant degree of accuracy.

The problem arises when aircraft are departing or approaching the airport when birds are also flying in the immediate vicinity. While it is unlikely that a single small bird, or a very few such birds, will cause sufficient damage to even a small aircraft to cause the aircraft to make a forced landing or to crash, small birds in sufficient numbers and lesser numbers of larger birds have been known to cause such aircraft accidents, as is well known. Generally speaking, the smaller the aircraft and/or the faster the aircraft is traveling, the greater the likelihood of damage in the event of a collision with a bird or birds. While larger aircraft may not be so likely to be disabled due to a bird strike, their generally higher speeds and greater frontal area increases the likelihood of a bird strike for such aircraft.

As a result, a number of different systems have been developed in the past in attempts to dissuade birds from populating airports and other areas in the immediate vicinity. Stationary devices producing periodic sharp sounds, e.g., carbide cannons and other explosive devices, have found limited success due to their stationary locations and the relatively long periods between explosions. Other efforts have been made to produce sounds that mimic the distress cries of bird species in the area, but again, the stationary deployment of such devices and their only periodic use tend to minimize their effectiveness. In some instances, birds of prey (hawks and falcons) have been used to reduce the bird population in such areas. However, such efforts likely do no more than reduce the rate of population growth among birds in the area due to the limited number of birds that can be attacked in a given area and period of time and the fact that the use of such birds of prey must be curtailed when aircraft are flying in the immediate vicinity, which is the usual situation on and around most airports.

Thus, a bird repellent system solving the aforementioned problems is desired.

### SUMMARY OF THE INVENTION

The bird repellent system is a mobile system in order to cover substantially the entire area of a large airport, and may include the immediately surrounding areas as well. While the present bird repellent system is adapted particularly for use on and around airports, it will be seen that it may be readily adapted to many other environments as well. The system includes a ground vehicle and an airborne vehicle, which communicate with one another for optimum effect. The vehicles are unmanned, and operate either autonomously or by remote control by a human operator, as required. The vehicles are programmed with a predetermined route of travel, and each includes a global positioning system (GPS) receiver for accurate navigation of the area. Each vehicle includes audio systems to repel birds from the vicinity. The audio repellent system may include distress calls of various species of birds in the area, or other sounds known to repel birds. The sounds may be in the range of human hearing, but may include sound frequencies in the ultrasonic region as well that are known to be detectable by various bird species.

The airborne vehicle of the system is preferably a rotorcraft, and more preferably a quad-rotor craft, in order to permit the craft to hover and loiter over a specific area as warranted by conditions. Both vehicles are equipped with solar cells for daylight operations and electrical storage batteries for operation when solar power is insufficient. The vehicles normally travel at a relatively slow speed, e.g., three mph, more or less. External signals may be sent to the craft to cause them to slow in a particular area, or to increase their speed through an area if there are few birds in the area. The airborne drone vehicle remains in relatively short range of the ground vehicle during normal operations, e.g., on the order of two hundred feet (more or less) above the ground vehicle, in order to optimize the repellent effect for birds both in flight and on the ground and to minimize interference with aircraft in the vicinity of the airport.

These and other features of the present invention will become readily apparent upon further review of the following specification and drawings.

### BRIEF DESCRIPTION OF THE DRAWINGS

FIG. 1 is an environmental, perspective view of a bird repellent system according to the present invention, illustrating its basic components and their relationship. LOOM FIG. 2 is a detailed perspective view of the remotely controlled or autonomously operated ground vehicle of the bird repellent system according to the present invention, illustrating various details thereof

FIG. 3 is a detailed perspective view of the remotely controlled or autonomously operated air vehicle of the bird repellent system according to the present invention, illustrating various details thereof

Similar reference characters denote corresponding features consistently throughout the attached drawings.

### DETAILED DESCRIPTION OF THE PREFERRED EMBODIMENTS

The bird repellent system utilizes a combination of autonomous or remotely controlled ground and airborne vehicles that continuously roam the grounds of the airport or other area where birds are to be dispelled. The two vehicles communicate with one another to work in concert with one another to repel birds from the area, whether the birds are on the ground or in flight.

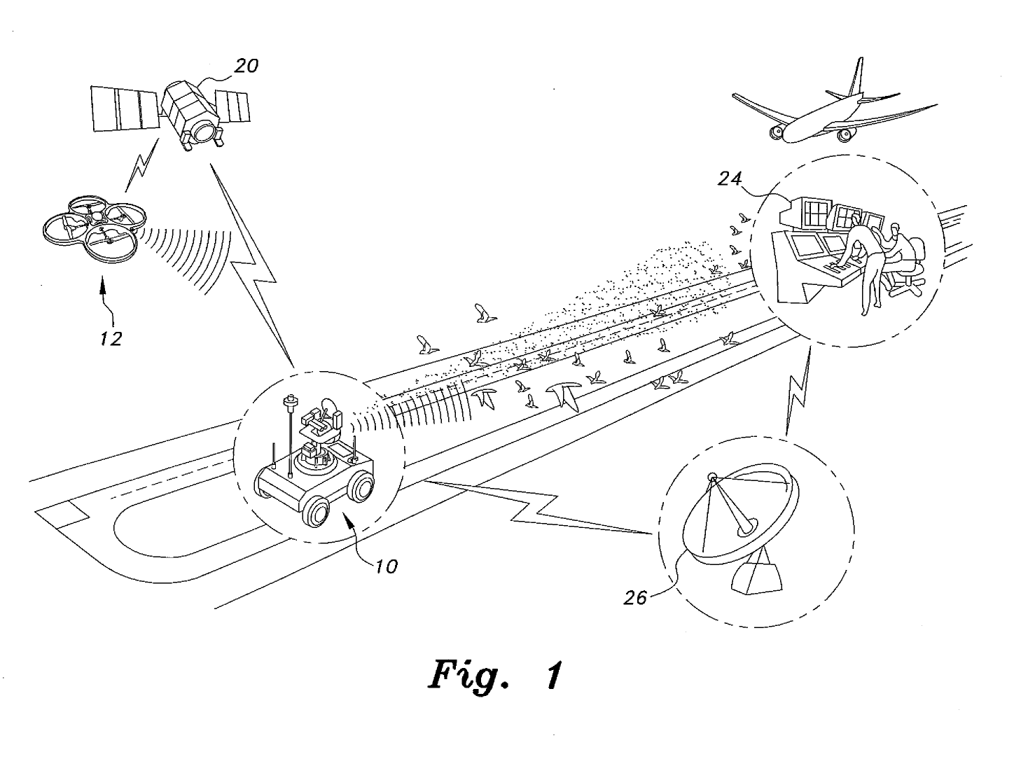

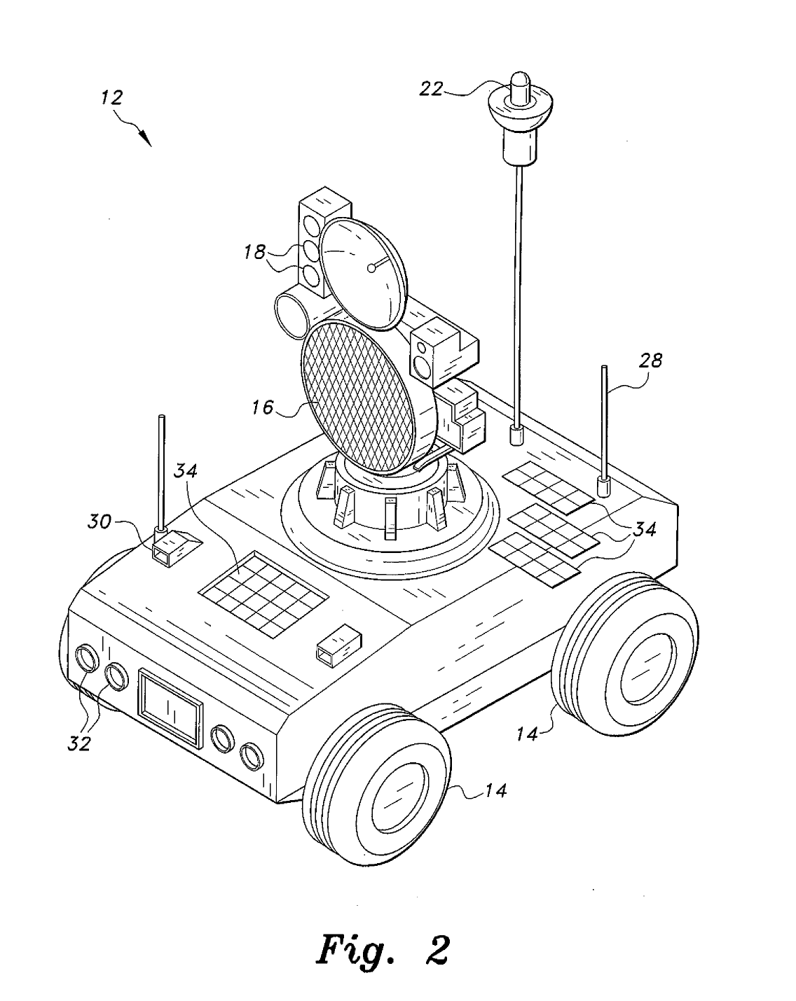

FIG. 1 of the drawings provides an environmental perspective view of the bird repellent system according to the present invention. The system includes an unoccupied drone ground vehicle 10 and an unoccupied drone airborne vehicle 12. The two vehicles 10 and 12 are capable of operating autonomously and following a predetermined route or path as they make their rounds of the designated area to repel birds therefrom. The airborne vehicle 12 is preferably electronically linked to the ground vehicle 10 to remain reasonably close thereto, e.g., on the order of two hundred to five hundred feet, although this range may be extended or contracted, as desired.

FIG. 2 of the drawings provides a more detailed view of the exemplary ground vehicle 10. The ground vehicle 10 is preferably driven and steered by wheels 14 for an airport environment where the vehicle may be operated on paved surfaces, and when operated off-pavement, the unpaved areas are relatively smooth and closely mowed. However, the ground vehicle 10 may be equipped with tracks, if so desired. The ground vehicle 10 includes an audio system to transmit sounds that are objectionable to bird species in the area, e.g., bird distress calls, etc. Such sounds are well known among ornithologists and may be readily recorded for replay by means of a conventional electronic sound system, with which the ground vehicle 10 may be equipped. The audio system may transmit sounds in the range of human hearing using a speaker 16, and may also transmit ultrasonic sounds beyond the range of human hearing but known to be within the range of hearing of certain bird species using ultrasonic speakers 18. These speakers 16 and 18 may be mounted on a turret for directional control, if desired, to obviate the need to turn or aim the entire vehicle 10.

The ground vehicle 10 preferably operates autonomously without any input from any remote human or other control, as noted further above. This may be accomplished by means of a conventional on-board computerized guidance system that is programmed with a predetermined route over which the vehicle 10 is to travel. The system may determine the location of the vehicle 10 by means of a conventional global positioning system (GPS) navigational system receiving navigational signals from the GPS satellite 20 (FIG. 1) via a suitable antenna 22. Other satellite navigational systems (e.g., GLOMAR) may be used in lieu of the GPS system. The GPS system, when combined with WAAS (Wide Area Augmentation Service), is capable of pinpointing the location of an appropriately configured receiver to within a very few feet, both horizontally and vertically.

There may be situations in which control of the vehicle 10 by a human operator(s) is desired, generally as illustrated in FIG. 1. This may be accomplished from a remotely located ground station 24, which transmits guidance and control signals to the vehicle 10 by means of an appropriate antenna system 26. The vehicle 10 may receive these control signals by means of a receiver antenna 28 and conventional control hardware, i.e., servos, etc. Such human control may be necessary to slow the vehicle 10 in certain areas where birds have congregated to a greater degree than normal, or conversely to accelerate the vehicle 10 across areas where no birds are located at the moment. Human control may also be needed from time to time to stop the vehicle or to move the vehicle from its predetermined path of travel to avoid other vehicles or obstructions. The ground vehicle 10 may include a conventional on-board video camera 30 for recording video images for transmittal back to the control center or ground station 24, so that the human controller(s) may determine the appropriate action(s) to take, depending upon the video received. The vehicle 10 also includes a series of warning lights 32 thereon to alert persons nearby of the operation of the vehicle 10. Such lights may be located atop and/or upon the rear of the vehicle 10.

The vehicle 10 is preferably electrically powered, using one or more conventional electric motors and a conventional electrical storage battery system. Electrical power for the drive system motor(s) and other electrical and electronic systems on board, e.g., the sound transmission and satellite navigation systems, may be provided by photovoltaic (solar) panels 34 disposed atop the vehicle 10. Periodic recharging of the on-board batteries may be provided from a ground station, as needed.

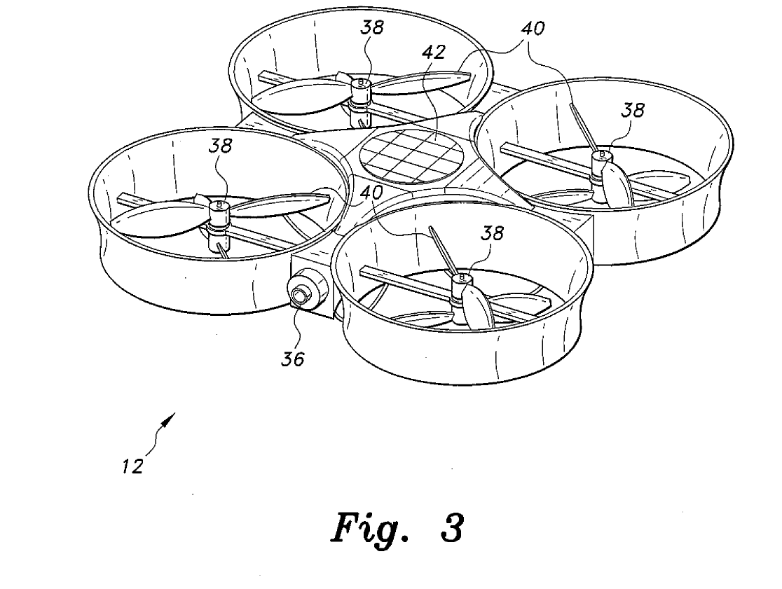

FIG. 3 illustrates an exemplary airborne vehicle 12 for use in the present bird repellent system. The airborne vehicle 12 is also preferably capable of autonomous operation through a conventional on-board computer and navigational system, substantially as provided for the ground vehicle 10 described further above. The airborne vehicle 12 communicates with the ground vehicle 10 and with the GPS satellite 20 to determine its position, as indicated in FIG. 1 of the drawings. The airborne vehicle 12 and ground vehicle 10 are preferably electronically linked to one another so that the airborne vehicle 12 remains in the same immediate area as the ground vehicle 10, e.g., within two hundred to five hundred feet of one another. This provides for the clearing of birds both on the ground and in flight from a given area, as noted further above, and simplifies the avoidance of the two vehicles by other vehicles or aircraft or the relocation of the ground and airborne vehicles 10 and 12 to remove them from the path of other vehicles.

The airborne vehicle 12 may be of any suitable configuration, but is preferably a rotorcraft capable of vertical takeoff and landing to minimize the required operational area. Most preferably the airborne vehicle 12 is a quad-rotor rotorcraft, as illustrated in FIG. 3. The airborne vehicle 12 is equipped with substantially the same bird repellent sound generation systems as the ground vehicle 10. The ultrasonic speaker or transmitter 36 is shown in FIG. 3, and other conventional speakers (not shown) for transmitting sounds in the range of normal human hearing may be installed on the airborne vehicle as well, e.g., beneath the vehicle. The airborne vehicle 12 is preferably electrically powered, having an electric motor 38 driving each set of vertically lifting propellers or rotors 40. Electrical power may be provided by conventional electrical storage batteries contained within the central structure of the vehicle 12, and photovoltaic cells (solar cells) 42 providing electrical energy to the extent feasible. The storage batteries of the vehicle 12 may be recharged conventionally as required by a ground recharging station.

It is to be understood that the present invention is not limited to the embodiments described above, but encompasses any and all embodiments within the scope of the following claims.

We claim:

1. A bird repellent system, comprising:
an unoccupied drone ground vehicle equipped for selective autonomous and remotely controlled operation;
an unoccupied drone airborne vehicle equipped for selective autonomous and remotely controlled operation, the airborne vehicle being coupled navigationally to the ground vehicle; and
an audio system disposed on each vehicle, the audio systems selectively producing bird repellent sounds in frequencies audible to humans and in ultrasonic frequencies.

2. The bird repellent system according to claim 1, wherein the airborne vehicle is a rotorcraft.

3. The bird repellent system according to claim 1 wherein the ground vehicle includes a global positioning system for navigation and a computer system having a predetermined route programmed therein, the ground vehicle navigating the predetermined route in accordance with navigation information provided by the global positioning system.

4. The bird repellent system according to claim 1, further comprising a ground station remotely disposed from the ground vehicle and from the airborne vehicle, the ground station having at least one transmitter for selectively transmitting signals to the ground vehicle and to the airborne vehicle, the ground vehicle and the airborne vehicle each having a receiver on board for receiving the signals transmitted from the ground station transmitter.

5. The bird repellent system according to claim 4, wherein the ground vehicle and the airborne vehicle each include a camera disposed thereon, the camera selectively transmitting visual images to the remotely disposed ground station.

6. The bird repellent system according to claim 1, wherein the ground vehicle and the airborne vehicle each include a plurality of photovoltaic solar cells disposed thereon.

7. The bird repellent system according to claim 1, wherein at least the ground vehicle includes at least one warning light thereon.

8. A bird repellent system, comprising:
an unoccupied drone airborne rotorcraft vehicle equipped for selective autonomous and remotely controlled operation; and
an audio system disposed on the vehicle, the audio system selectively producing bird repellent sounds in frequencies audible to humans and in ultrasonic frequencies.

9. The bird repellent system according to claim 8, further comprising:
an unoccupied drone ground vehicle equipped for selective autonomous and remotely controlled operation, the ground vehicle including a global positioning system for navigation and a computer system having a predetermined route programmed therein, the ground vehicle navigating the predetermined route in accordance with navigation information provided by the global positioning system; and
an audio system disposed on the ground vehicle, the audio system selectively producing bird repellent sounds in frequencies audible to humans and in ultrasonic frequencies.

10. The bird repellent system according to claim 9, wherein the airborne vehicle is coupled navigationally to the ground vehicle.

11. The bird repellent system according to claim 9, further comprising a ground station remotely disposed from the ground vehicle and from the airborne vehicle, the ground station having at least one transmitter for selectively transmitting signals to the ground vehicle and to the airborne vehicle, the ground vehicle and the airborne vehicle each having a receiver on board for receiving the signals transmitted from the ground station transmitter.

12. The bird repellent system according to claim 11 wherein the ground vehicle and the airborne vehicle each include a camera disposed thereon, the camera selectively transmitting visual images to the remotely disposed ground station.

13. The bird repellent system according to claim 9, wherein the ground vehicle and the airborne vehicle each include a plurality of photovoltaic solar cells disposed thereon.

14. The bird repellent system according to claim 9, wherein at least the ground vehicle includes at least one warning light thereon.

15. A bird repellent system, comprising:
an unoccupied drone ground vehicle equipped for selective autonomous and remotely controlled operation, the ground vehicle including a global positioning system for navigation and a computer system having a predetermined route programmed therein, the ground vehicle navigating the predetermined route in accordance with navigation information provided by the global positioning system; and
an audio system disposed on the ground vehicle, the audio system selectively producing bird repellent sounds in frequencies audible to humans and in ultrasonic frequencies.

16. The bird repellent system according to claim 15, further comprising:
an unoccupied drone airborne vehicle equipped for selective autonomous and remotely controlled operation, the airborne vehicle being coupled navigationally to the ground vehicle; and
an audio system disposed on the airborne vehicle, the audio system selectively producing bird repellent sounds in frequencies audible to humans and in ultrasonic frequencies.

17. The bird repellent system according to claim 16, wherein the airborne vehicle is a rotorcraft.

18. The bird repellent system according to claim 16, further comprising a ground station remotely disposed from the ground vehicle and from the airborne vehicle, the ground station having at least one transmitter for selectively transmitting signals to the ground vehicle and to the airborne vehicle, the ground vehicle and the airborne vehicle each having a receiver on board for receiving the signals transmitted from the ground station transmitter.

19. The bird repellent system according to claim 18 wherein the ground vehicle and the airborne vehicle each include a camera disposed thereon, the camera selectively transmitting visual images to the remotely disposed ground station.

20. The bird repellent system according to claim 16, wherein:
the ground vehicle and the airborne vehicle each include a plurality of photovoltaic solar cells disposed thereon; and
at least the ground vehicle includes at least one warning light thereon.
